(19) United States
(12) Patent Application Publication
(10) Pub. No.: US 2026/0158741 A1
(43) Pub. Date: Jun. 11, 2026

(54) Three-Dimensional Object Printing Apparatus And Printing Method

(71) Applicant: SEIKO EPSON CORPORATION, Tokyo (JP)

(72) Inventors: Masaru KUMAGAI, Shiojiri (JP); Kazushi WADA, Matsumoto (JP)

(21) Appl. No.: 19/410,328

(22) Filed: Dec. 5, 2025

(30) Foreign Application Priority Data
Dec. 6, 2024 (JP) 2024-213120

(51) Int. Cl. B29C 64/241; B25J 17/00; B29C 64/209; B29C 64/379; B33Y 10/00; B33Y 30/00; B33Y 40/00

(52) U.S. Cl. CPC B29C 64/241; B25J 17/00; B29C 64/209; B29C 64/379; B33Y 10/00; B33Y 30/00; B33Y 40/00

(57) ABSTRACT

A three-dimensional object printing apparatus executes a printing operation in which a robot moves a head along a printing region of a workpiece, and in the printing operation, when a position on the printing region where the head starts to eject the liquid is defined as a start point, and a position on the printing region where the head ends to eject the liquid is defined as an end point, in side view of the robot when viewed from a side at a timing when the head ejects the liquid toward the start point in the printing operation, the start point is closer to the base portion than is the end point in a first direction parallel to an installation surface of the base portion, and farther from the installation surface than is the end point in a second direction parallel to a normal of the installation surface.

The present application is based on, and claims priority from JP Application Serial Number 2024-213120, filed Dec. 6, 2024, the disclosure of which is hereby incorporated by reference herein in its entirety.

### BACKGROUND

### 1. Technical Field

The present disclosure relates to a three-dimensional object printing apparatus and a printing method.

### 2. Related Art

A three-dimensional object printing apparatus that performs printing on a surface of a three-dimensional workpiece by an ink jet method is known. For example, JP-A-2022-170964 discloses an apparatus in which a robot moves a head away from a base portion of the robot while ejecting ink from the head during execution of a printing operation.

In the apparatus described in JP-A-2022-170964, there is room for improvement in widening the printing region of the workpiece as much as possible while suppressing vibration of the head caused by the operation of the robot.

### SUMMARY

According to one aspect of the present disclosure, a three-dimensional object printing apparatus includes a head configured to eject a liquid toward a three-dimensional workpiece, and a robot including an arm and a base portion coupled to one end of the arm, the robot being configured to change a relative position between the workpiece and the head, in which the three-dimensional object printing apparatus executes a printing operation in which the robot moves the head along a printing region of the workpiece while the liquid is ejected from the head, and in the printing operation, when a position on the printing region where the head starts to eject the liquid is defined as a start point, and a position on the printing region where the head ends to eject the liquid is defined as an end point, in side view of the robot when viewed from a side at a timing when the head ejects the liquid toward the start point in the printing operation, the start point is closer to the base portion than is the end point in a first direction parallel to an installation surface of the base portion, and farther from the installation surface than is the end point in a second direction parallel to a normal of the installation surface.

According to one aspect of the present disclosure, a printing method using a three-dimensional object printing apparatus including a head configured to eject a liquid toward a three-dimensional workpiece, and a robot including an arm and a base portion coupled to one end of the arm, the robot being configured to change a relative position between the workpiece and the head, the printing method includes determining a start point, which is a position on a printing region of the workpiece where the head starts to eject the liquid toward the printing region, and an end point, which is a position on the printing region where the head ends to eject the liquid toward the printing region, and executing a printing operation in which the robot moves the head along the printing region while the liquid is ejected from the head, based on the start point and the end point, in which, in side view of the robot when viewed from a side at a timing when the head ejects the liquid toward the start point in the printing operation, the start point is closer to the base portion than is the end point in a first direction parallel to an installation surface of the base portion, and farther from the installation surface than is the end point in a second direction parallel to a normal of the installation surface.

### BRIEF DESCRIPTION OF THE DRAWINGS

FIG. 1 is a schematic view of a three-dimensional object printing apparatus according to an embodiment.

FIG. 2 is a block diagram showing an electrical configuration of the three-dimensional object printing apparatus according to the embodiment.

FIG. 3 is a perspective view of a robot.

FIG. 4 is a flowchart showing a printing method according to the embodiment.

FIG. 5 is a diagram showing a state of the robot at a timing when a head ejects a liquid toward a start point of a printing region in a printing operation.

FIG. 6 is a diagram showing a state of the robot at a timing when the head ejects the liquid toward an end point of the printing region in the printing operation.

FIG. 7 is an explanatory diagram of a movement path of the head in the printing operation.

### DESCRIPTION OF EMBODIMENTS

Hereinafter, preferred embodiments according to the present disclosure will be described with reference to the attached drawings. In the drawings, dimensions and scale of each portion are appropriately different from actual ones, and some parts are schematically shown for easy understanding. In addition, the scope of the present disclosure is not limited to these embodiments unless otherwise stated to limit the present disclosure in the following description.

In the following description, for convenience, an X axis, a Y axis, and a Z axis that intersect with each other will be appropriately used. In addition, hereinafter, one direction along the X axis is an X1 direction, and a direction opposite to the X1 direction is an X2 direction. Similarly, directions opposite to each other along the Y axis are a Y1 direction and a Y2 direction. Further, directions opposite to each other along the Z axis are a Z1 direction and a Z2 direction.

Here, the X axis, the Y axis, and the Z axis are coordinate axes of a world coordinate system set in the space in which a robot 2 and a holding robot 4 to be described later are installed. Typically, the Z axis is a vertical axis, and the Z2 direction corresponds to a downward direction in a vertical direction. A base coordinate system based on base portions 210 and 410 to be described later is associated with the world coordinate system by calibration. Hereinafter, for convenience, a case where operations of the robot 2 and the holding robot 4 are controlled by using the world coordinate system as a robot coordinate system will be exemplified.

The Z axis may not be a vertical axis. Although the X axis, the Y axis, and the Z axis are typically orthogonal to each other, the present disclosure is not limited thereto, and the axes may not be orthogonal to each other. For example, the X axis, Y axis, and Z axis may intersect with each other at an angle within a range of 80° or more and 100° or less.

### 1. First Embodiment

### 1-1. Outline of Three-Dimensional Object Printing Apparatus

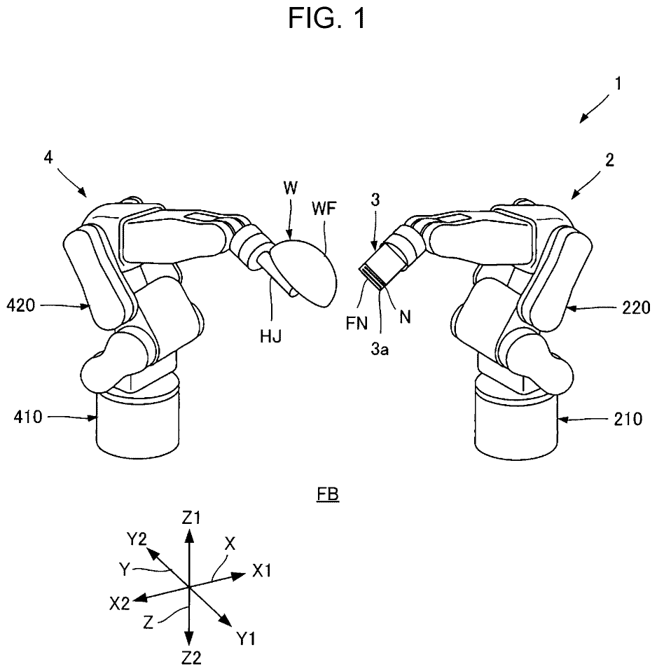

FIG. 1 is a schematic view of a three-dimensional object printing apparatus 1 according to an embodiment. The three-dimensional object printing apparatus 1 is the apparatus that performs printing on a surface of a three-dimensional workpiece W by an ink jet method.

The workpiece W has a surface WF including a printing region RP to be printed, which will be described later. In the example shown in FIG. 1, the workpiece W is a substantially hemispherical body, and the surface WF is a substantially projecting spherical surface. A size, a shape, or an installation orientation of the workpiece W is not limited to the example shown in FIG. 1, and is appropriately selected.

As shown in FIG. 1, the three-dimensional object printing apparatus 1 includes the robot 2, a head unit 3, and the holding robot 4. Hereinafter, first, each portion of the three-dimensional object printing apparatus 1 will be sequentially and briefly described with reference to FIG. 1.

The robot 2 is a robot that supports the head unit 3 and changes a position and an orientation of the head unit 3 in the world coordinate system. In the example shown in FIG. 1, the robot 2 is a so-called six-axis vertical articulated robot.

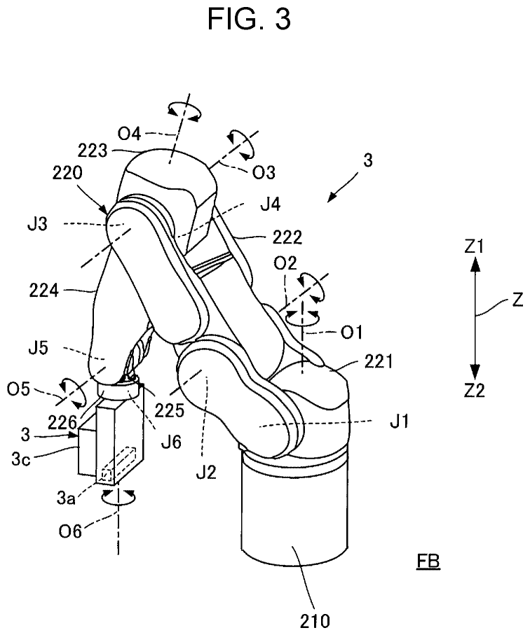

The robot 2 includes a base portion 210 and an arm 220. The base portion 210 is a base that supports the arm 220 and is fixed to an installation surface FB by screwing or the like. The arm 220 is a robot arm, and a head unit 3 as an end effector is mounted to a tip end of the arm 220 in a state of being fixed by screwing or the like. As described above, the robot 2 includes the arm 220 and the base portion 210 coupled to one end of the arm 220, and changes a relative position between the workpiece W and a head 3a. Details of the robot 2 will be described later with reference to FIG. 3.

The installation surface FB is a surface facing the Z1 direction, and is, for example, an outer surface of an installation base or a floor surface of a building. The installation surface FB is not limited to the outer surface of the installation base or the floor surface of the building, and may be, for example, a wall surface or a ceiling surface of the building.

The head unit 3 is an assembly having the head 3a that ejects an ink, which is an example of a “liquid”, toward the workpiece W. The head 3a has a nozzle surface FN, and a plurality of nozzles N for ejecting the ink are opened in the nozzle surface FN. The plurality of nozzles N constitute one or more nozzle rows arranged in a straight line. In the present embodiment, the head unit 3 includes a curing light source 3c in addition to the head 3a. The head unit 3 will be described later in detail with reference to FIG. 3.

The ink is not particularly limited, and examples thereof include an aqueous ink in which a coloring material such as a dye or a pigment is dissolved in an aqueous solvent, a curable ink using a curable resin such as an ultraviolet curable type resin, a solvent-based ink in which a coloring material such as a dye or a pigment is dissolved in an organic solvent, and the like. Among the inks, the curable ink is preferably used. The curable ink is not particularly limited, and may be, for example, any of a thermosetting type, a photo-curing type, a radiation curing type, an electron beam curing type, and the like, but a photo-curing type such as an ultraviolet curable type is suitable.

On the other hand, the holding robot 4 is a robot that holds the workpiece W and changes the position and the orientation of the workpiece W in the world coordinate system. In the example shown in FIG. 1, the holding robot 4 is a six-axis vertical articulated robot.

The holding robot 4 includes a base portion 410 and an arm 420. The base portion 410 is a base that supports the arm 420 and is fixed to the installation surface FB by screwing or the like. The arm 420 is a robot arm, and a holding mechanism HJ as an end effector is mounted on a tip end of the arm 420 in a state of being fixed by screwing or the like.

The holding robot 4 is configured in the same manner as the robot 2 except that the end effector to be mounted is different. However, the robot 2 and the holding robot 4 may have different configurations from each other, and in the present embodiment, the configurations such as the arm length or the weight capacity are different from each other as necessary. Further, the number of joints of the robot 2 and the holding robot 4 may be different from each other. The base portion 410 may be fixed to a surface different from the installation surface FB, or may be fixed to a surface different from that of the base portion 210 of the robot 2. For example, the robot 2 may be installed on one of a floor, a wall, and a ceiling, and the holding robot 4 may be installed on another one, or the robot 2 may be installed on one of a plurality of walls facing different directions from each other, and the holding robot 4 may be installed on another one.

The holding mechanism HJ is a robot hand that detachably holds the workpiece W. Here, “holding” is a concept including both sucking and gripping. For example, as the holding mechanism HJ, a suction mechanism for the workpiece W by negative pressure, an attraction mechanism by magnetic force, a gripping hand mechanism having a plurality of fingers, claws, or the like, and the like are exemplified.

Each of the robot 2, the head unit 3, and the holding robot 4 described above operates under the control of a control unit 10 to be described later. For example, under the control of the control unit 10 to be described later, in a state in which the holding robot 4 disposes the workpiece W at a desired position, the robot 2 moves the head unit 3 along the surface WF of the workpiece W while the head unit 3 ejects the ink toward the surface WF of the workpiece W. Accordingly, the three-dimensional object printing apparatus 1 performs a printing operation in which the robot 2 moves the head 3a along a printing region RP, which will be described later, of the workpiece W while ejecting the ink from the head 3a.

Here, the holding robot 4 changes one or both of the position and the orientation of the workpiece W before the printing operation. As a result, manual orientation change or position adjustment of the workpiece W can be omitted.

The holding robot 4 may be omitted as necessary. In this case, the workpiece W is installed at a desired position in a desired orientation by a jig that holds the workpiece W. In addition, the workpiece W may be installed manually.

### 1-2. Electrical Configuration of Three-Dimensional Object Printing Apparatus

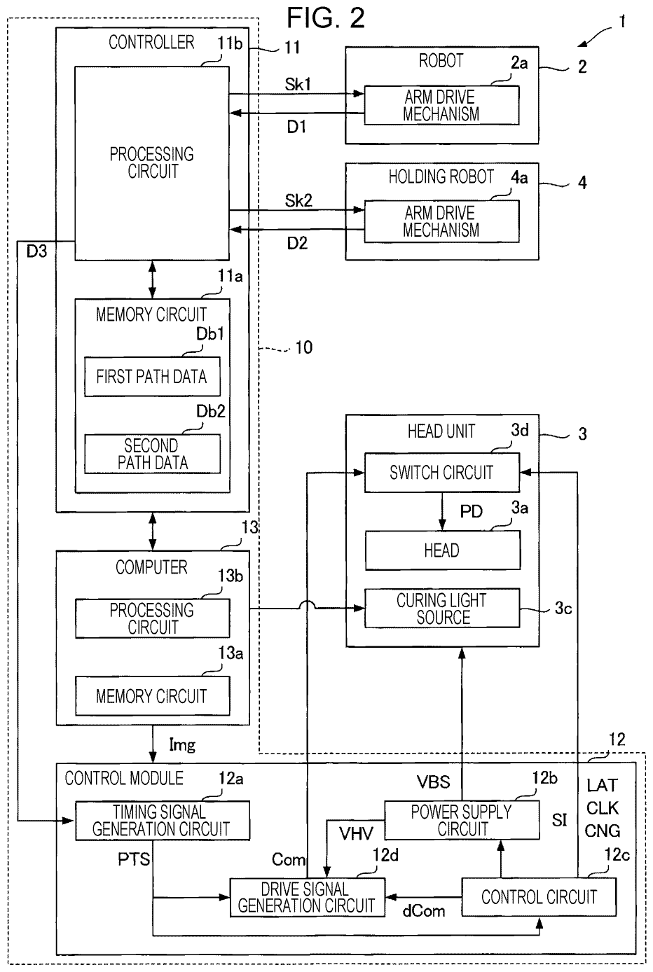

FIG. 2 is a block diagram showing an electrical configuration of the three-dimensional object printing apparatus 1 according to the embodiment. In FIG. 2, among components of the three-dimensional object printing apparatus 1, electrical components are shown. As shown in FIG. 2, the three-dimensional object printing apparatus 1 includes the control unit 10 in addition to the robot 2, the head unit 3, and the holding robot 4 described above.

The control unit 10 controls operations of the robot 2, the head unit 3, and the holding robot 4. In the example shown in FIG. 2, the control unit 10 includes a controller 11, a control module 12, and a computer 13.

Each electrical component shown in FIG. 2 may be appropriately divided, a part thereof may be included in another component, or may be integrally formed with the other component. For example, a part or all of the functions of the controller 11 or the control module 12 may be realized by the computer 13, or may be realized by another external apparatus such as a personal computer (PC) connected to the controller 11 via a network such as a local area network (LAN) or the Internet.

The controller 11 is a robot controller that controls driving of the robot 2 and the holding robot 4. The controller 11 has a function of controlling driving of the robot 2 and the holding robot 4, and a function of generating a signal D3 for synchronizing an ink ejection operation in the head unit 3 with an operation of the robot 2. The controller 11 includes a memory circuit 11a and a processing circuit 11b.

The memory circuit 11a stores various programs to be executed by the processing circuit 11b and various types of data to be processed by the processing circuit 11b. The memory circuit 11a includes, for example, one or both semiconductor memories of a volatile memory such as a random access memory (RAM) and a non-volatile memory such as a read only memory (ROM), an electrically erasable programmable read-only memory (EEPROM) or a programmable ROM (PROM). A part or all of the memory circuit 11a may be included in the processing circuit 11b.

The memory circuit 11a stores first path data Db1 and second path data Db2.

The first path data Db1 is information relating to a movement path of the head unit 3 by the robot 2, and includes information indicating the position and the orientation of the head 3a in the printing operation. The movement path indicated by the first path data Db1 includes positions corresponding to a start point PS and an end point PE, which will be described later. The second path data Db2 is information relating to a movement path of the workpiece W by the holding robot 4, and includes information indicating the position and the orientation of the workpiece W during the printing operation and before and after the printing operation. Here, the movement path indicated by the second path data Db2 includes the start point PS and the end point PE, which will be described later. Each of the first path data Db1 and the second path data Db2 is generated by the computer 13.

The processing circuit 11b controls an operation of an arm drive mechanism 2a of the robot 2 based on the first path data Db1, and generates the signal D3. Further, the processing circuit 11b controls an operation of an arm drive mechanism 4a of the holding robot 4 based on the second path data Db2. The processing circuit 11b includes, for example, one or more processors such as a central processing unit (CPU). The processing circuit 11b may include a programmable logic device such as a field-programmable gate array (FPGA) instead of the CPU or in addition to the CPU.

The arm drive mechanism 2a includes a motor for driving each joint of the robot 2 and an encoder for detecting a rotation angle of each joint of the robot 2.

Similarly, the arm drive mechanism 4a includes a motor for driving each joint of the holding robot 4 and an encoder for detecting a rotation angle of each joint of the holding robot 4.

The processing circuit 11b performs inverse kinematics calculation which is a calculation that converts the position and the orientation indicated by the first path data Db1 into operation amounts such as rotation angles and rotation speeds of respective joints of the robot 2. Then, the processing circuit 11b outputs a control signal Sk1 based on output D1 from the respective encoders of the arm drive mechanism 2a so that the actual operation amounts such as the rotation angles and rotation speeds of the respective joints become the above-described calculation result. The control signal Sk1 controls the driving of the motor of the arm drive mechanism 2a.

Similarly, the processing circuit 11b performs inverse kinematics calculation which is a calculation that converts the position and the orientation indicated by the second path data Db2 into operation amounts such as rotation angles and rotation speeds of respective joints of the holding robot 4. Then, the processing circuit 11b outputs a control signal Sk2 based on output D2 from the respective encoders of the arm drive mechanism 4a so that the actual operation amounts such as the rotation angles and rotation speeds of the respective joints become the above-described calculation result. The control signal Sk2 controls the driving of the motor of the arm drive mechanism 4a.

In addition, the processing circuit 11b generates the signal D3 based on the output D1 from at least one of the plurality of encoders of the arm drive mechanism 2a. For example, the processing circuit 11b generates, as the signal D3, a trigger signal including a pulse at a timing at which the output D1 from one of the plurality of encoders becomes a predetermined value.

The control module 12 is a circuit module that is communicably connected to the controller 11 and that controls the head unit 3. The control module 12 is a circuit that controls the ink ejection operation in the head unit 3 based on the signal D3 output from the controller 11 and printing data Img from the computer 13. The control module 12 includes a timing signal generation circuit 12a, a power supply circuit 12b, a control circuit 12c, and a drive signal generation circuit 12d.

The timing signal generation circuit 12a generates a timing signal PTS, based on the signal D3. The timing signal generation circuit 12a is configured with, for example, a timer that starts generation of the timing signal PTS by using detection of the signal D3 as a trigger.

The power supply circuit 12b receives power supply from a commercial power supply (not shown) to generate various predetermined potentials. The various generated potentials are appropriately supplied to each portion of the control module 12 and the head unit 3. For example, the power supply circuit 12b generates a power supply potential VHV and an offset potential VBS. The offset potential VBS is supplied to the head unit 3. In addition, the power supply potential VHV is supplied to the drive signal generation circuit 12d.

The control circuit 12c generates a control signal SI, a waveform designation signal dCom, a latch signal LAT, a clock signal CLK, and a change signal CNG, based on the timing signal PTS. These signals are synchronized with the timing signal PTS. Among these signals, the waveform designation signal dCom is input to the drive signal generation circuit 12d, and the other signals are input to a switch circuit 3d of the head unit 3.

The control signal SI is a digital signal for designating an operation state of a drive element included in the head 3a of the head unit 3. Specifically, the control signal SI designates whether to supply a drive signal Com, which will be described later, to the drive element. With this designation, for example, whether to eject the ink from a nozzle corresponding to the drive element is designated, and the amount of ink ejected from the nozzle is designated. The waveform designation signal dCom is a digital signal for defining a waveform of the drive signal Com. The latch signal LAT and the change signal CNG are used together with the control signal SI and by defining a driving timing of the drive element, define an ejection timing of ink from the nozzle. The clock signal CLK is a reference clock signal synchronized with the timing signal PTS.

The control circuit 12c described above includes, for example, one or more processors such as a central processing unit (CPU). The control circuit 12c may include a programmable logic device such as a field-programmable gate array (FPGA) instead of the CPU or in addition to the CPU.

The drive signal generation circuit 12d is a circuit that generates the drive signal Com for driving each drive element included in the head 3a of the head unit 3. Specifically, the drive signal generation circuit 12d includes, for example, a DA conversion circuit and an amplifier circuit. In the drive signal generation circuit 12d, the DA conversion circuit converts the waveform designation signal dCom from the control circuit 12c from a digital signal to an analog signal, and the amplifier circuit uses the power supply potential VHV from the power supply circuit 12b to amplify the analog signal and generate the drive signal Com. The drive signal Com is supplied from the drive signal generation circuit 12d to the drive element via the switch circuit 3d of the head unit 3. Here, among waveforms included in the drive signal Com, a signal of a waveform actually supplied to the drive element is a drive pulse PD. The switch circuit 3d switches whether to supply at least a part of the waveforms included in the drive signal Com as the drive pulse PD, based on the control signal SI.

The computer 13 is a desktop type, a laptop type, a tablet type, or another type of computer that is communicably connected to the controller 11 and the control module 12. The computer 13 has a function of generating the first path data Db1 and the second path data Db2, a function of supplying information such as the first path data Db1 and the second path data Db2 to the controller 11, and a function of supplying information such as the printing data Img to the control module 12.

The computer 13 includes a memory circuit 13a and a processing circuit 13b. The memory circuit 13a stores various programs to be executed by the processing circuit 13b and various types of data to be processed by the processing circuit 13b. The various programs include, for example, a program for determining a start point PS and an end point PE, which will be described later. The memory circuit 13a includes, for example, one or both semiconductor memories of a volatile memory such as a RAM and a non-volatile memory such as a ROM, an EEPROM, or a PROM. A part or all of the memory circuit 13a may be included in the processing circuit 13b.

The processing circuit 13b realizes the above-described various functions by reading and executing the program from the memory circuit 13a. The processing circuit 13b includes, for example, one or more processors such as a CPU. The processing circuit 13b may include a programmable logic device such as an FPGA instead of the CPU or in addition to the CPU.

### 1-3. Configuration Example of Robot

FIG. 3 is a perspective view of the robot 2. Hereinafter, a configuration example of the robot 2 will be described. Since the configuration of the holding robot 4 is the same as that of the robot 2 except that the mounted end effector is different, the description thereof will be omitted. However, as described above, the configurations of the robot 2 and the holding robot 4 may be different from each other.

In the example shown in FIG. 3, the arm 220 of the robot 2 is a six-axis robot arm having a base end attached to the base portion 210 and a tip end whose position and orientation are three-dimensionally changed with respect to the base end. Specifically, the arm 220 includes arms 221, 222, 223, 224, 225, and 226, which are also referred to as links, and these are coupled in this order. The arm 226 is an example of a “tip end portion”.

The arm 221 is coupled to the base portion 210 via a joint J1 that rotates about a rotation axis O1. The rotation axis O1 is an example of a “first rotation axis”, and the joint J1 is an example of a “first joint”. The arm 222 is coupled to the arm 221 via a joint J2 that rotates about a rotation axis O2. The rotation axis O2 is an example of a “second rotation axis”, and the joint J2 is an example of a “second joint”. The arm 223 is coupled to the arm 222 via a joint J3 that rotates about a rotation axis O3. The rotation axis O3 is an example of a “third rotation axis”, and the joint J3 is an example of a “third joint”. The arm 224 is coupled to the arm 223 via a joint J4 that rotates about a rotation axis O4. The rotation axis O4 is an example of a “fourth rotation axis,” and the joint J4 is an example of a “fourth joint.” The arm 225 is coupled to the arm 224 via a joint J5 that rotates about a rotation axis O5. The rotation axis O5 is an example of a “fifth rotation axis,” and the joint J5 is an example of a “fifth joint.” The arm 226 is coupled to the arm 225 via a joint J6 that rotates about a rotation axis O6. The rotation axis O6 is an example of a “sixth rotation axis,” and the joint J6 is an example of a “sixth joint.” As described above, the arm 220 has the joints J1 to J6. The joints J2, J3, J4, and J6 are provided in this order from the base portion 210 toward the arm 226 of the arm 220.

Each of the joints J1 to J6 is a mechanism that rotatably couples one of two adjacent members of the base portion 210 and the arms 221 to 226 to the other. Although not shown in FIG. 3, each of the joints J1 to J6 is provided with a drive mechanism for rotating one of the two adjacent members with respect to the other. The drive mechanism includes, for example, a motor that generates a driving force for the rotation, a speed reducer that decelerates and outputs the driving force, and an encoder such as a rotary encoder that detects an operation amount such as an angle of the rotation. An assembly of the drive mechanisms of the joints J1 to J6 corresponds to the above-described arm drive mechanism 2a shown in FIG. 2.

The rotation axis O1 is an axis perpendicular to the installation surface FB to which the base portion 210 is fixed. The rotation axis O2 is an axis perpendicular to the rotation axis O1. The rotation axis O3 is an axis parallel to the rotation axis O2. The rotation axis O4 is an axis perpendicular to the rotation axis O3. The rotation axis O5 is an axis perpendicular to the rotation axis O4. The rotation axis O6 is an axis perpendicular to the rotation axis O5.

With respect to these rotation axes, the term “perpendicular” includes not only the case where the angle formed by the two rotation axes is exactly 90°, but also the case where the angle formed by the two rotation axes intersects within a range of about ±5° from 90°. Similarly, the term “parallel” includes not only the case where the two rotation axes are strictly parallel to each other but also the case where one of the two rotation axes is inclined with respect to the other within a range of about ±5°.

The head unit 3 is mounted as an end effector on the arm 226 which is a tip end portion of the arm 220 described above. The head unit 3 is mounted on the arm 226 such that, for example, a normal of the nozzle surface FN is parallel to the rotation axis O6, that is, the ejection direction of the ink from the nozzle N is parallel to the rotation axis O6. The normal of the nozzle surface FN or the ejection direction of the ink from the nozzle N may be inclined with respect to the rotation axis O6.

Here, a tool coordinate system is set in the head unit 3. The coordinate axes of the tool coordinate system change the relative position and orientation relationship with the above-described X axis, Y axis, and Z axis by the above-described operation of the robot 2. However, the tool coordinate system and the above-described base coordinate system are associated with each other by calibration. In addition, the tool coordinate system is set such that, for example, the center of the nozzle surface FN becomes a reference (tool center point).

As described above, the head unit 3 includes the head 3a and the curing light source 3c, and these are supported by the arm 226 in a state in which a relative positional relationship is fixed via a support body (not shown).

Although not shown, the head 3a includes a piezoelectric element which is a drive element and a cavity for accommodating inks, for each nozzle N. Here, the piezoelectric element ejects the ink from a nozzle corresponding to the cavity by changing a pressure of the cavity corresponding to the piezoelectric element.

The curing light source 3c emits energy such as light, heat, an electron beam, or radiation for curing or solidifying the ink on the workpiece W. The curing light source 3c is formed of, for example, a light emitting element such as a light emitting diode (LED) that emits ultraviolet rays.

The curing light source 3c may be provided or omitted as necessary. In addition to the head 3a and the curing light source 3c, the head unit 3 may include, for example, a pressure regulating valve that regulates the pressure of the ink in the head 3a.

### 1-4. Printing Method

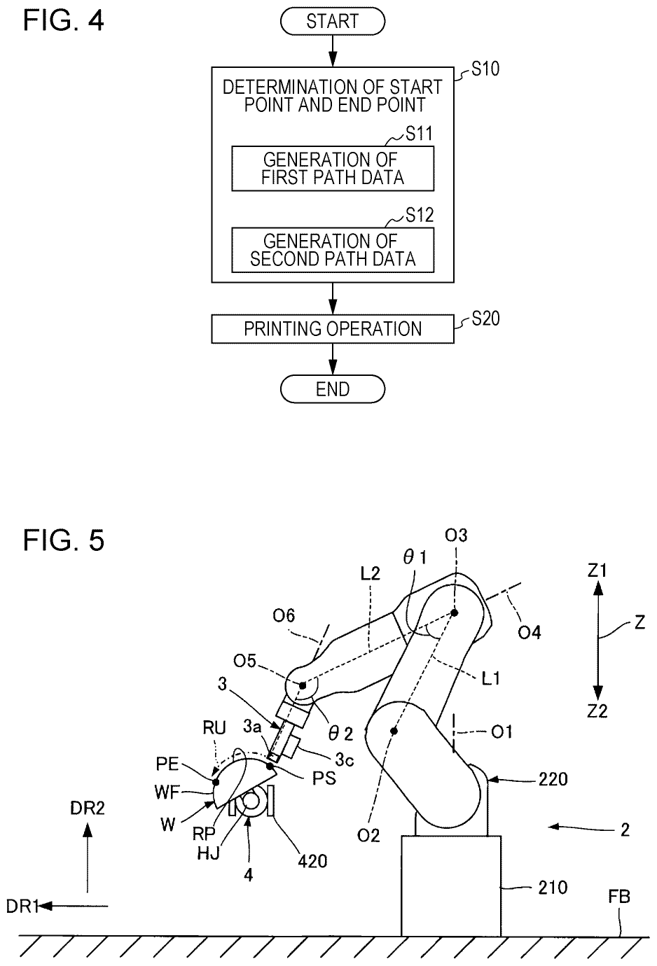

FIG. 4 is a flowchart showing a printing method according to the embodiment. The printing method shown in FIG. 4 is performed using the above-described three-dimensional object printing apparatus 1, and includes Step S10 and Step S20 in this order.

In Step S10, the control unit 10 determines a start point PS and an end point PE, which will be described later. As will be described later with reference to FIGS. 5 to 7, the start point PS is a position on a printing region RP, which will be described later, at which the head 3a starts to eject ink in the printing operation. In addition, the end point PE is a position on a printing region RP, which will be described later, at which the head 3a ends to eject ink in the printing operation.

In the example shown in FIG. 4, Step S10 includes Step S11 of generating the above-described first path data Db1 and Step S12 of generating the above-described second path data Db2.

In Step S11, for example, the computer 13 generates first path data Db1 by calculating the position and the orientation of the head 3a in the workpiece coordinate system so that the head 3a moves along the printing region RP to be described later in the printing operation, based on the information indicating the shape of the workpiece W and the information indicating the printing region RP to be described later, and then converting the position and the orientation into the robot coordinate system. At this time, the first path data Db1 is determined so that the start point PS and the end point PE, which will be described later, have a positional relationship as will be described later. The generated first path data Db1 is transmitted from the computer 13 to the controller 11 and is stored in the memory circuit 11a. Although not shown, in Step S10, the printing data Img is generated based on the information indicating the image to be printed and the first path data Db1.

In Step S12, for example, the computer 13 generates second path data Db2 by calculating the position and the orientation of the workpiece W in the workpiece coordinate system so that the workpiece W corresponds to a movement path indicated by the first path data Db1 in the printing operation, based on information indicating a shape of the workpiece W and the first path data Db1, and then converting the position and the orientation into the robot coordinate system. At this time, the second path data Db2 is determined so that the start point PS and the end point PE, which will be described later, have a positional relationship as will be described later. The generated second path data Db2 is transmitted from the computer 13 to the controller 11 and is stored in the memory circuit 11a.

In Step S20, the control unit 10 executes the printing operation based on the start point PS and the end point PE. Specifically, in Step S20, while the processing circuit 11b controls an operation of the robot 2 based on the first path data Db1 in a state in which the processing circuit 11b controls an operation of the holding robot 4 based on the second path data Db2, the control module 12 controls an ejection operation of ink by the head 3a based on the signal D3 and the printing data Img.

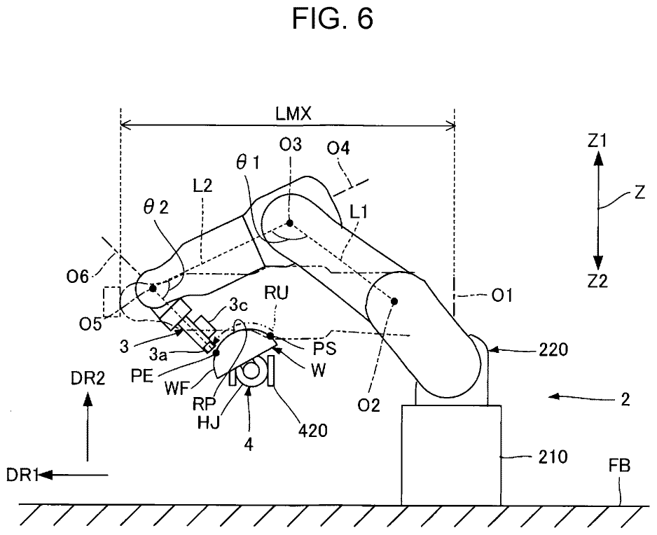

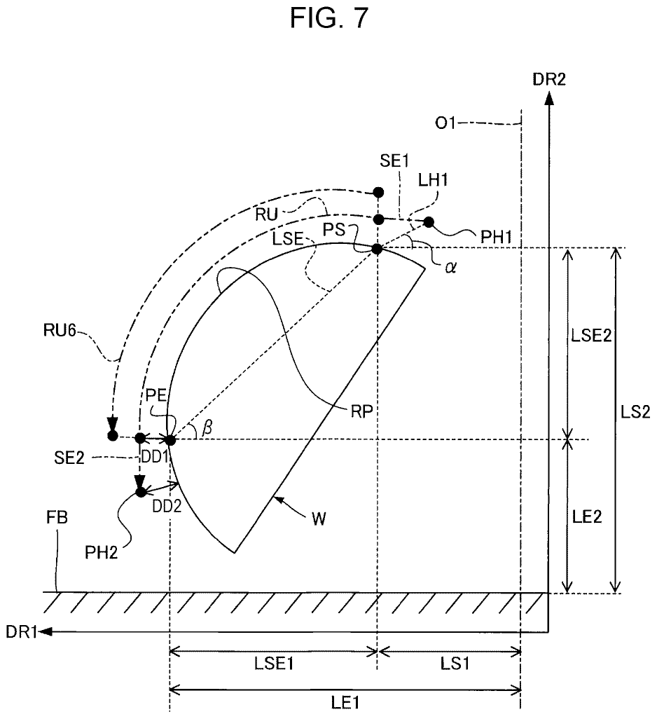

FIG. 5 is a diagram showing a state of the robot 2 at a timing at which the head 3a ejects ink toward the start point PS of the printing region RP in the printing operation of Step S20. FIG. 6 is a diagram showing a state of the robot 2 at a timing at which the head 3a ejects ink toward the end point PE of the printing region RP in the printing operation of Step S20. FIG. 7 is an explanatory diagram of the movement path of the head 3a in the printing operation of Step S20.

In the printing operation, as shown in FIGS. 5 and 6, while the robot 2 moves the head 3 a in a state in which the holding robot 4 supports the workpiece W, the head 3a ejects the ink toward the printing region RP on the workpiece W.

Here, the robot 2 moves the head 3a along a movement path RU based on the first path data Db1. The movement path RU is a path along the printing region RP on the workpiece W. Further, the holding robot 4 disposes the workpiece W based on the second path data Db2 before the operation of the robot 2 based on the first path data Db1.

In the present embodiment, in the printing operation, the holding robot 4 does not operate, and the robot 2 operates. Therefore, vibration of the workpiece W can be prevented. Here, from the viewpoint of reducing meandering of the movement path RU of the head 3a, it is preferable that the number of joints operated by the robot 2 in the printing operation is as small as possible. Therefore, in FIGS. 5 and 6, an aspect in which the head 3a is moved by operations of joints J2, J3, and J5 of three rotation axes O2, O3, and O5 parallel to each other is exemplified. In this aspect, from the viewpoint of reducing meandering of the movement path RU of the head 3a, it is preferable that the joints other than the joints J2, J3, and J5 are not operated. Accordingly, the movement path RU has a linear shape when viewed in the direction along the Z axis. In the printing operation, the rotation axis O5 may be non-parallel to the rotation axes O2 and O3, and joints other than the joints J2, J3, and J5 may operate. Further, the movement path RU may be curved or bent when viewed in the direction along the Z axis.

In the example shown in FIGS. 5 and 6, in the printing operation, the robot 2 changes the arm 220 from a retracted state to an extended state. Thereby, it is possible to reduce the vibration of the head 3a due to the operation of the robot 2, compared to the aspect in which the arm 220 is changed from the extended state to the retracted state.

In side view in which the robot 2 is viewed from the side at a timing when the head 3a ejects ink toward the start point PS in the printing operation, the start point PS which is a position on the printing region RP where the head 3a starts to eject ink is closer to the base portion 210 than is the end point PE in a first direction DR1 parallel to the installation surface FB of the base portion 210. In addition, in the plan view, the start point PS is farther from the installation surface FB than is the end point PE which is a position on the printing region RP where the head 3a ends to eject the ink in a second direction DR2 parallel to the normal of the installation surface FB.

That is, in the side view, as shown in FIG. 7, a distance LS1 between the start point PS in the first direction DR1 and the base portion 210 is shorter than a distance LE1 between the end point PE in the first direction DR1 and the base portion 210, and a distance LS2 between the start point PS in the second direction DR2 and the installation surface FB is longer than a distance LE2 between the end point PE in the second direction DR2 and the installation surface FB. A position of the base portion 210 in the first direction DR1 is based on the rotation axis O1. Therefore, it can be said that the distance LS1 is a distance between the start point PS in the first direction DR1 and the rotation axis O1, and it can be said that the distance LE1 is a distance between the end point PE in the first direction DR1 and the rotation axis O1.

By disposing the start point PS and the end point PE in such a positional relationship, in the printing operation, the robot 2 can be operated so as to swing down the head 3a, that is, so as to move toward the installation surface FB as the head 3a moves away from the base portion 210. As a result, it is possible to secure a wide printing region RP while suppressing the vibration of the head 3a caused by the operation of the robot 2.

The “side surface of the robot 2” is a surface facing a direction along the rotation axis O2 or the rotation axis O3 of the robot 2. Therefore, the “side view of the robot 2” refers to a view in a direction along the rotation axis O2 or the rotation axis O3 of the robot 2.

A virtual line segment LSE connecting the start point PS and the end point PE is closer to the base portion 210 than is a movement path RU6 of the joint J6 in the printing operation. As a result, as the head 3a moves from the start point PS toward the end point PE, the head 3a moves so as to be drawn into the robot 2. For this reason, it is possible to suppress the extension amount of the arm 220 compared to an aspect in which the head 3a moves linearly from the start point PS toward the end point PE. As a result, it is possible to secure a wide printing region RP while suppressing the vibration of the head 3a caused by the operation of the robot 2.

The joint J6, which is an example of a “sixth joint”, is the joint closest to the head 3a, that is, the joint at the extreme tip among the plurality of joints J1 to J6 of the robot 2.

When the robot 2 is a six-axis robot as in the present embodiment, the head 3a needs to rotate about the rotation axis O5 of the robot 2. Here, in the first direction DR1, as shown by a two dot chain line in FIG. 6, when a distance between the arm 226 of the arm 220 and the base portion 210 when the arm 220 is maximally extended is a first distance LMX, each of the distance LS1 between the start point PS and the base portion 210 and the distance LE1 between the end point PE and the base portion 210 is preferably equal to or greater than ½ of the first distance LMX and less than the first distance LMX. Accordingly, it is possible to suitably suppress the vibration of the head 3a caused by the operation of the robot 2, and as a result, it is possible to improve the printing quality.

On the other hand, when the distance LS1 between the start point PS and the base portion 210 is less than ½ times the first distance LMX, the rotation amount of the joint J5 of the robot 2 increases, and as a result, the vibration of the head 3a caused by the operation of the robot 2 in the printing operation is likely to increase. When the distance LS1 between the start point PS and the base portion 210 is less than ½ times the first distance LMX, there are many points on the front side of the robot 2 that define movement limits of the robot 2, which complicates the generation of the printing path. On the other hand, when the distance LS1 between the start point PS and the base portion 210 is equal to or more than the first distance LMX, the arm 220 is fully extended, and thus the vibration of the head 3a caused by the operation of the robot 2 is likely to be large.

“When the robot 2 is extended to the maximum” means when the joint at the extreme tip of the robot 2 is farthest from the base portion 210.

The joint J2 rotates about the rotation axis O2. The rotation axis O2 extends in a direction intersecting both the first direction DR1 and the second direction DR2. Here, in the second direction DR2, each of the start point PS and the end point PE is preferably located in a direction (Z2 direction) toward the installation surface FB relative to the rotation axis O2. That is, each of the distances between the start point PS in the second direction DR2 and the installation surface FB and between the end point PE in the second direction DR2 and the installation surface FB is shorter than the distance between the rotation axis O2 in the second direction DR2 and the installation surface FB. Accordingly, even when the wide printing region RP is secured, it is possible to suppress the collision between the robot 2 and the workpiece W. In the second direction DR2, each of the start point PS and the end point PE may coincide with the rotation axis O2, or may be located in the Z1 direction relative to the rotation axis O2.

The distance LSE1 between the start point PS and the end point PE in the first direction DR1 may be equal to or different from the distance LSE2 between the start point PS and the end point PE in the second direction DR2.

When the distance LSE1 between the start point PS and the end point PE in the first direction DR1 is shorter than the distance LSE2 between the start point PS and the end point PE in the second direction DR2, the vibration caused by the extension of the robot 2 can be suppressed by suppressing the operation of the robot 2 to extend in the first direction DR1.

On the other hand, when the distance LSE2 between the start point PS and the end point PE in the second direction DR2 is shorter than the distance LSE1 between the start point PS and the end point PE in the first direction DR1, and when the second direction DR2 is a direction along the vertical axis, the vertical displacement of the head 3a can be reduced to suppress deterioration of the ejection characteristics due to fluctuations in the negative pressure within the head 3a.

In the printing operation, the head 3a rotates about the rotation axis O5 that extends in a direction intersecting the first direction DR1. At this time, a rotation range of the head 3a rotating about the rotation axis O5 is preferably between +90 degrees and −90 degrees, and more preferably between +45 degrees and −45 degrees. Accordingly, there is an advantage that the printing region RP is easily widened. In addition, when the second direction DR2 is a direction along the vertical axis, since the nozzle surface of the head 3a does not face vertically upward, it is possible to suppress a risk that the negative pressure in the head 3a in the printing operation is weakened. As a result, it is possible to improve the printing quality. In particular, when the rotation range is between +45 degrees and −45 degrees, it is possible to suitably improve the printing quality by suitably suppressing the fluctuation of the negative pressure in the head 3a.

Here, a container containing the liquid to be supplied to the head 3a is attached to, for example, the arm 226 of the robot 2 together with the head 3a. The container may be disposed outside the robot 2. In this case, the container is, for example, coupled to the head 3a via a tube for transferring the liquid to the head 3a. In addition, the “rotation range of the head 3a rotating about the rotation axis O5” described above is a range of rotation angles in which a state in which the nozzle surface of the head 3a faces a direction (a direction facing the installation surface FB) opposite to the second direction DR2 is set as a reference (0 degrees).

When viewed along the rotation axis O2, a virtual line segment connecting the joint J2 and the joint J3 is referred to as a first virtual line segment L1, a virtual line segment connecting the joint J3 and the joint J5 is referred to as a second virtual line segment L2, and an angle formed by the first virtual line segment L1 and the second virtual line segment L2 is referred to as a first angle θ1. In the printing operation, it is preferable that the first angle θ1 at the timing when the head 3a ejects the ink toward the start point PS is 30 degrees or more, and the first angle θ1 at the timing when the head 3a ejects the ink toward the end point PE is 170 degrees or less.

The first virtual line segment L1 can be said to be a virtual line segment connecting the center of the joint J2 and the center of the joint J3 when viewed along the rotation axis O2 or the rotation axis O3, and can be said to be a virtual line segment connecting the rotation axis O2 and the rotation axis O3. The second virtual line segment L2 can be said to be a virtual line segment connecting the center of the joint J3 and the center of the joint J5 when viewed along the rotation axis O2 or the rotation axis O3, or can be said to be a virtual line segment connecting the rotation axis O3 and the rotation axis O5 when the rotation axis O3 and the rotation axis O5 are parallel to each other.

When the first angle θ1 is in such an angle range, it is possible to suitably suppress deterioration in printing qualities due to vibration of the head 3a caused by the operation of the robot 2 in the printing operation. On the other hand, when the first angle θ1 at the timing when the head 3a ejects the ink toward the start point PS is smaller than 30 degrees, the dependency of the rotation of the joint J5 on the orientation change of the head 3a becomes high. Therefore, in order to secure a necessary displacement of the head 3a, the rotation amount of the joint J5 increases, so that vibration of the head 3a caused by the operation of the robot 2 in the printing operation tends to increase, and as a result, there is a risk that printing quality deteriorates. In addition, when the first angle θ1 at the timing at which the head 3a ejects the ink toward the end point PE is larger than 170 degrees, the amount of variation in the extension of the robot 2 is larger than the amount of displacement of the head 3a, and thus the ejection timing of the liquid by the head 3a is likely to deviate.

When an angle formed by the rotation axis O4 and the rotation axis O6 when viewed along the rotation axis O2 is set as a second angle θ2, in the printing operation, when the variation amount of the second angle θ2 is smaller than the variation amount of the first angle θ1, it is possible to make the rotation amount of the joint J5 smaller than the rotation amount of the joint J3. Therefore, it is possible to reduce the amount of displacement of the head 3a, and as a result, it is possible to suppress the vibration of the head 3a caused by the operation of the robot 2.

On the other hand, in the printing operation, when the variation amount of the second angle θ2 is larger than the variation amount of the first angle θ1, it is possible to make the rotation amount of the joint J5 larger than the rotation amount of the joint J3. Therefore, it is possible to increase the degree of freedom in setting the positions of the start point PS and the end point PE, and as a result, it is possible to widen the printing region RP.

The variation amount of the angle in the printing operation refers to a difference between the maximum value and the minimum value of the angle varied from the time when the head 3a ejects the ink toward the start point PS to the time when the head 3a ends to eject the ink toward the end point PE.

In the printing operation, when a position of the head 3a in a pre-eject approach section SE1 in which the head 3a moves to a position for ejecting the ink toward the start point PS is set as a first point PH1, when viewed from the side, an angle α formed between the first direction DR1 and a virtual line segment LH1 connecting the first point PH1 and the start point PS is preferably smaller than an angle β formed between the first direction DR1 and a virtual line segment LSE connecting the start point PS and the end point PE. As a result, it is possible to suppress the vibration of the head 3a at the timing of ejecting the ink toward the start point PS. As a result, it is possible to improve the printing quality.

The first point PH1 is located at a start position of the pre-eject approach section SE1 in the drawing, but may be located at an intermediate position of the pre-eject approach section SE1. Also in this case, the angle α is preferably smaller than the angle β.

From the viewpoint of suppressing the vibration of the head 3a at the start of the printing operation, the pre-eject approach section SE1 is preferably along a tangent line of a virtual circle which is centered on the rotation axis O2 and passes through the start point PS.

In the printing operation, when a position of the head 3a in a post-eject approach section SE2 in which the head 3a moves after ejecting the ink toward the end point PE is set as a second point PH2, when viewed from the side, a distance DD2 between the second point PH2 and the workpiece W is preferably greater than a distance DD1 between the head 3a and the workpiece W at a timing when the head 3a ejects the ink toward the end point PE. Thus, even if the arm 220 vibrates after passing through the end point PE, the head 3a is moved so as to be away from the workpiece W, so that collision of the head 3a with the workpiece W can be suppressed.

Although the second point PH2 is located at an end position of the post-eject approach section SE2 in the drawing, it may be located at an intermediate position of the post-eject approach section SE2. Even in this case, it is preferable that the distance DD2 is greater than the distance DD1.

Since the inclination of the printing region RP with respect to the installation surface FB becomes large in the vicinity of the end point PE, when the second direction DR2 is along the vertical axis, there is a risk that the ejected ink drips. In this case, the curing light source 3c that emits light for curing or solidifying the ink may be moved so as to approach the end point PE.

### 2. Modification Examples

The embodiments exemplified above can be modified in various ways. Specific modification aspects that can be applied to each of the embodiments described above are exemplified below. Two or more aspects appropriately selected from the following examples can be appropriately combined within a range in which the two or more aspects do not contradict each other.

### 2-1. Modification Example 1

In the above-described embodiment, a configuration in which a six-axis vertical multi-axis robot is used as a moving mechanism is exemplified, but the present disclosure is not limited to the configuration. The moving mechanism may be capable of three-dimensionally changing the relative position and the orientation of a liquid ejecting head with respect to the workpiece. Therefore, the moving mechanism may be, for example, a vertical multi-axis robot other than a six-axis robot or may be a horizontal multi-axis robot. In addition, the robot arm may have an expansion/retraction mechanism or the like in addition to the joint constituted by the rotation mechanism. However, from the viewpoint of the balance between the printing quality in the printing operation and the degree of freedom of the operation of the moving mechanism in the non-printing operation, the moving mechanism is preferably a multi-axis robot having six or more axes. Further, a dual-arm robot may be used, and in this case, one arm can be used as a first robot, and the other arm can be used as a second robot.

For example, in the case of a seven-axis robot, a seventh joint from the base portion toward the tip end is the joint at the extreme tip, and the seventh joint corresponds to the “sixth joint”. In addition, the plurality of joints of the multi-axis robot correspond to a “first joint”, a “second joint”, a “third joint”, a “fourth joint”, and a “fifth joint” in order from the base portion side to the tip end side.

### 2-2. Modification Example 2

In the above-described embodiment, a configuration in which screwing or the like is used as a method of fixing the head to the robot is exemplified, but the disclosure is not limited to the configuration. For example, the head may be fixed to the robot by gripping the head by a gripping mechanism such as a hand mounted as an end effector of the robot.

### 2-3. Modification Example 3

In the embodiment described above, a configuration in which printing is performed by using one type of ink is described. Meanwhile, the present disclosure is not limited to this configuration and can be applied to a configuration in which printing is performed by using two or more types of ink.

### 2-4. Modification Example 4

The use of the three-dimensional object printing apparatus of the present disclosure is not limited to printing. For example, a three-dimensional object printing apparatus that ejects a solution of a coloring material is used as a manufacturing apparatus that forms a color filter of a liquid crystal display apparatus. A three-dimensional object printing apparatus that ejects a solution of a conductive material is used as a manufacturing apparatus that forms a wiring and an electrode on a wiring substrate. Further, the three-dimensional object printing apparatus can also be used as a jet dispenser that applies a liquid such as an adhesive to a workpiece.

What is claimed is:

1. A three-dimensional object printing apparatus comprising:
a head configured to eject a liquid toward a three-dimensional workpiece; and
a robot including an arm and a base portion coupled to one end of the arm, the robot being configured to change a relative position between the workpiece and the head, wherein the three-dimensional object printing apparatus executes a printing operation in which the robot moves the head along a printing region of the workpiece while the liquid is ejected from the head, and
in the printing operation,
when a position on the printing region where the head starts to eject the liquid is defined as a start point, and
a position on the printing region where the head ends to eject the liquid is defined as an end point,
in side view of the robot when viewed from a side at a timing when the head ejects the liquid toward the start point in the printing operation,
the start point is
closer to the base portion than is the end point in a first direction parallel to an installation surface of the base portion, and
farther from the installation surface than is the end point in a second direction parallel to a normal of the installation surface.

2. The three-dimensional object printing apparatus according to claim 1, wherein
the arm has joints, and
a virtual line segment connecting the start point and the end point is closer to the base portion than is a movement path of a first joint in the printing operation, the first joint being closest to the head among the joints.

3. The three-dimensional object printing apparatus according to claim 1, wherein
in the first direction,
when a distance between a tip end portion of the arm when the arm is maximally extended and the base portion is defined as a first distance,
each of a distance between the start point and the base portion and a distance between the end point and the base portion is equal to or greater than ½ of the first distance and less than the first distance.

4. The three-dimensional object printing apparatus according to claim 1, wherein
the arm has a second joint among joints, the second joint being configured to rotate about a second rotation axis extending in a direction intersecting both the first direction and the second direction,
in the second direction,
each of the start point and the end point is located closer to the installation surface than is the second rotation axis.

5. The three-dimensional object printing apparatus according to claim 1, wherein
a distance between the start point and the end point in the first direction is shorter than a distance between the start point and the end point in the second direction.

6. The three-dimensional object printing apparatus according to claim 1, wherein
a distance between the start point and the end point in the second direction is shorter than a distance between the start point and the end point in the first direction.

7. The three-dimensional object printing apparatus according to claim 1, wherein
in the printing operation,
the head rotates about a rotation axis extending in a direction intersecting the first direction, and
a rotation range of the head rotating about the rotation axis is between +90 degrees and −90 degrees.

8. The three-dimensional object printing apparatus according to claim 7, wherein
the rotation range of the head is between +45 degrees and −45 degrees.

9. The three-dimensional object printing apparatus according to claim 1, wherein
the arm has
a second joint configured to rotate about a second rotation axis extending in a direction intersecting the first direction,
a third joint configured to rotate about a third rotation axis parallel to the second rotation axis,
a fourth joint configured to rotate about a fourth rotation axis intersecting the third rotation axis, and
a fifth joint configured to rotate about a fifth rotation axis intersecting the fourth rotation axis,
the second joint, the third joint, the fourth joint, and the fifth joint are provided in this order from the base portion toward a tip end portion of the arm, and
when viewed along the second rotation axis,
when a virtual line segment connecting the second joint and the third joint is defined as a first virtual line segment,
a virtual line segment connecting the third joint and the fifth joint is defined as a second virtual line segment, and
an angle formed by the first virtual line segment and the second virtual line segment is defined as a first angle,
in the printing operation,
the first angle at a timing when the head ejects the liquid toward the start point is 30 degrees or more, and
the first angle at a timing when the head ejects the liquid toward the end point is 170 degrees or less.

10. The three-dimensional object printing apparatus according to claim 1, wherein
the arm has
a second joint configured to rotate about a second rotation axis extending in a direction intersecting the first direction,
a third joint configured to rotate about a third rotation axis parallel to the second rotation axis,
a fourth joint configured to rotate about a fourth rotation axis intersecting the third rotation axis,
a fifth joint configured to rotate about a fifth rotation axis intersecting the fourth rotation axis, and
a sixth joint configured to rotate about a sixth rotation axis intersecting the fifth rotation axis,
the second joint, the third joint, the fourth joint, the fifth joint, and the sixth joint are provided in this order from the base portion toward a tip end portion of the arm, and
when viewed along the second rotation axis,
when a virtual line segment connecting the second joint and the third joint is defined as a first virtual line segment,
a virtual line segment connecting the third joint and the fifth joint is defined as a second virtual line segment,
an angle formed by the first virtual line segment and the second virtual line segment is defined as a first angle, and
an angle formed by the fourth rotation axis and the sixth rotation axis is defined as a second angle,
in the printing operation,
a variation amount of the second angle is smaller than a variation amount of the first angle.

11. The three-dimensional object printing apparatus according to claim 1, wherein
the arm includes
a second joint configured to rotate about a second rotation axis extending in a direction intersecting the first direction,
a third joint configured to rotate about a third rotation axis parallel to the second rotation axis,
a fourth joint configured to rotate about a fourth rotation axis intersecting the third rotation axis,
a fifth joint configured to rotate about a fifth rotation axis intersecting the fourth rotation axis, and
a sixth joint configured to rotate about a sixth rotation axis intersecting the fifth rotation axis,
the second joint, the third joint, the fourth joint, the fifth joint, and the sixth joint are provided in this order from the base portion toward a tip end portion of the arm, and
when viewed along the second rotation axis,
when a virtual line segment connecting the second joint and the third joint is defined as a first virtual line segment,
a virtual line segment connecting the third joint and the fifth joint is defined as a second virtual line segment,
an angle formed by the first virtual line segment and the second virtual line segment is defined as a first angle, and
an angle formed by the fourth rotation axis and the sixth rotation axis is defined as a second angle,
in the printing operation,
a variation amount of the second angle is larger than a variation amount of the first angle.

12. The three-dimensional object printing apparatus according to claim 1, wherein
in the printing operation, when a position of the head in a pre-eject approach section in which the head moves to a position for ejecting the liquid toward the start point is defined as a first point,
when viewed from the side,
an angle formed by the first direction and a virtual line segment connecting the first point and the start point is smaller than an angle formed by the first direction and a virtual line segment connecting the start point and the end point.

13. The three-dimensional object printing apparatus according to claim 1, wherein
in the printing operation, when a position of the head in a post-eject approach section in which the head moves after ejecting the liquid toward the end point is defined as a second point,
when viewed from the side,
a distance between the second point and the workpiece is greater than a distance between the head and the workpiece at a timing when the head ejects the liquid toward the end point.

14. The three-dimensional object printing apparatus according to claim 1, further comprising:
a holding robot configured to hold the workpiece, wherein
the holding robot changes one or both of a position and an orientation of the workpiece before the printing operation.

15. A printing method using a three-dimensional object printing apparatus including
a head configured to eject a liquid toward a three-dimensional workpiece, and
a robot including an arm and a base portion coupled to one end of the arm, the robot being configured to change a relative position between the workpiece and the head, the printing method comprising:
determining a start point, which is a position on a printing region of the workpiece where the head starts to eject the liquid toward the printing region, and an end point, which is a position on the printing region where the head ends to eject the liquid toward the printing region; and
executing a printing operation in which the robot moves the head along the printing region while the liquid is ejected from the head, based on the start point and the end point, wherein
in side view of the robot when viewed from a side at a timing when the head ejects the liquid toward the start point in the printing operation,
the start point is closer to the base portion than is the end point in a first direction parallel to an installation surface of the base portion, and
farther from the installation surface than is the end point in a second direction parallel to a normal of the installation surface.
